(19) United States
(12) Patent Application Publication
(10) Pub. No.: US 2011/0232318 A1
(43) Pub. Date: Sep. 29, 2011

(54) Motor with Three-In-One Operation

(75) Inventors: Emilio A. Ramirez, JR., Roselle, IL (US); Ralph A. Bley, McHenry, IL (US)

(73) Assignee: Molon Motor and Coil Corporation, Arlington Heights, IL (US)

(21) Appl. No.: 13/070,972

(22) Filed: Mar. 24, 2011

Related U.S. Application Data
(60) Provisional application No. 61/316,921, filed on Mar. 24, 2010.

(51) Int. Cl. F25C 5/02; H02K 11/00

(52) U.S. Cl. 62/320; 310/68 R

(57) ABSTRACT

A gear motor assembly capable of operation in three modes and the method of operating the assembly in such modes, is disclosed herein. The assembly is generally comprised of a reversible motor having an input shaft, a gear train assembly coupled to the input shaft, an output shaft coupled to the gear train assembly, a power source, electrically coupled to the motor, for producing an operating voltage, and an input signal for directing the operating voltage from the power source through one of either a relay for switching the polarity of the operating voltage directed from the power source to the motor, thereby reversing the motor and a voltage control circuit for reducing the voltage to the motor. The motor is capable of operation, based on the input signal, at any one of a first speed in a clockwise direction, a first speed in a counter-clockwise direction, and a second speed.

### RELATED APPLICATION

This application claims the Mar. 24, 2010 filing benefit of U.S. Provisional Application No. 61/316,921 titled “Motor With 3 in 1 Operation” and herein incorporates by reference the same.

### TECHNICAL FIELD OF THE INVENTION

The present invention relates generally to ice machines, and in particular to a system and method for operating a motor in the production and dispensing of shaved, crushed and cubed ice.

### BACKGROUND OF THE INVENTION

Conventional ice makers have been used in household refrigerators for many years, and typically are located in the freezer section of a side-by-side refrigerator. Such ice makers may also have an ice dispenser which makes it very convenient for a user to fill a glass or some other container with ice, be it cubed ice, crushed ice or even shaved ice. When used on “through door” ice dispensers it also eliminates the need to open the freezer door and let ambient air into the freezer section.

Very early ice dispensers are described in U.S. Pat. No. 3,422,994 issued Jan. 21, 1969, U.S. Pat. No. 3,437,244 issued Apr. 8, 1969, and U.S. Pat. No. 3,602,441 issued Aug. 31, 1971. In general, such dispensers include a receptacle or bucket that receives and stores ice pieces or cubes from an automatic ice maker. A feed section or lift wheel at the front of the ice bucket includes a horizontal cylindrical collar that contains a metering helix such as a spiraled vane or a double bladed screw auger. When the lift wheel is rotated in response to depressing an actuator on the outside of the freezer door, the metering helix lifts ice pieces up and through a discharge opening in the front end of the receptacle from where they fall down a chute into the user's glass. The lift wheel maintains the delivery rate of the ice pieces within prescribed limits for convenience, and also provides a moderate flow rate of ice pieces independently of the fill level of ice pieces within the receptacle.

The prior art also recognized the desirability of providing crushed and shaved ice rather than conventional cubed ice pieces. To provide this feature, the ice pieces are typically delivered to an ice crusher/shaver section in front of the receptacle that includes a horizontal substantially cylindrical chamber having the necessary stationary and rotating blades or arms to produce the desired ice form. A motor is coupled to the rotating blades to provide the necessary rotational drive. The ice is crushed between the respective sets of blades, and falls down a chute into the waiting glass or container.

It has also been found desirable to provide an ice dispenser wherein a selection can be made between cubed ice, shaved ice and crushed ice. That is, it is desirable to provide an option to operate the dispenser so that the ice is delivered whole, shaved or crushed. One such selective ice dispenser is described in U.S. Pat. No. 3,602,441 issued Aug. 31, 1971. With the apparatus described therein, ice pieces are delivered from the lift wheel or feed section through the discharge opening to a chamber or transfer space having an outlet opening generally below the inlet opening. Another selective ice dispenser is described in U.S. Pat. No. 4,176,527 issued Dec. 4, 1979. In the apparatus described therein, an ice crusher includes first and second crusher arms mounted to a rotatable shaft. The '441 and '527 patents are hereby incorporated by reference.

There is a need for a motor which is capable of operation in three modes to allow for production and/or delivery of ice in cubed, shaved or crushed form.

### SUMMARY OF THE INVENTION

The present invention can generally be described as a gear motor assembly capable of operation in three modes. The assembly is generally comprised of a reversible motor having an input shaft, a gear train assembly coupled to the input shaft, an output shaft coupled to the gear train assembly, a power source, electrically coupled to the motor, for producing an operating voltage, and an input signal for directing the operating voltage from the power source through one of either a relay for switching the polarity of the operating voltage directed from the power source to the motor, thereby reversing the motor and a voltage control circuit for reducing the voltage to the motor. The motor is capable of operation, based on the input signal, at any one of a first speed in a clockwise direction, a first speed in a counter-clockwise direction, and a second speed.

When coupled with an ice making machine, such as that used in a refrigerator/freezer, the motor facilitates production and delivery of ice in the form of cubes, shaved ice or crushed ice.

The present invention can also be characterized as a method for operating a gear motor assembly having a reversible motor with an input shaft, a gear train assembly coupled to the input shaft, an output shaft coupled to the gear train assembly and a power source, electrically coupled to the motor, for producing an operating voltage, capable of three modes of operation. The method comprises the steps of applying a first operating voltage to the motor to turn the output shaft in a first direction at a first speed, changing the polarity of the first operating voltage to turn the output shaft in a second direction at the first speed, and reducing the first operating voltage in a voltage control circuit to turn the output shaft at a second speed slower than the first speed.

These and other advantages and embodiments can be more readily understood from a review of the following written description and the appended drawings.

### BRIEF DESCRIPTION OF THE DRAWINGS

For the purpose of facilitating an understanding of the subject matter sought to be protected, there are illustrated in the accompanying drawings embodiments thereof, for an inspection of which, when considered in connection with the following description, the subject matter sought to be protected, its construction and operation, and many of its advantages should be readily understood and appreciated.

FIG. 1 is a perspective view of a gear motor assembly in accordance with the present invention;

FIG. 2 is a back elevation view of the gear motor assembly of FIG. 1 wherein an input connector is provided for receiving an input voltage;

FIG. 3 is an angled back view of the gear motor assembly of FIGS. 1 and 2 wherein the lid to the gear motor assembly has been removed, thus exposing a base motor and a pair of printed circuit boards contained within the gear motor assembly; and

FIG. 4 is a simplified electrical schematic of the electrical circuitry contained on the printed circuits boards of FIG. 3 for introducing power to the base motor contained within the gear motor assembly of FIGS. 1-3.

### DETAILED DESCRIPTION OF THE INVENTION

While this invention is susceptible to embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment(s) illustrated. U.S. Pat. No. 6,924,612 to Ramirez Jr., titled “Three-Way Reversing System” is hereby incorporated by reference.

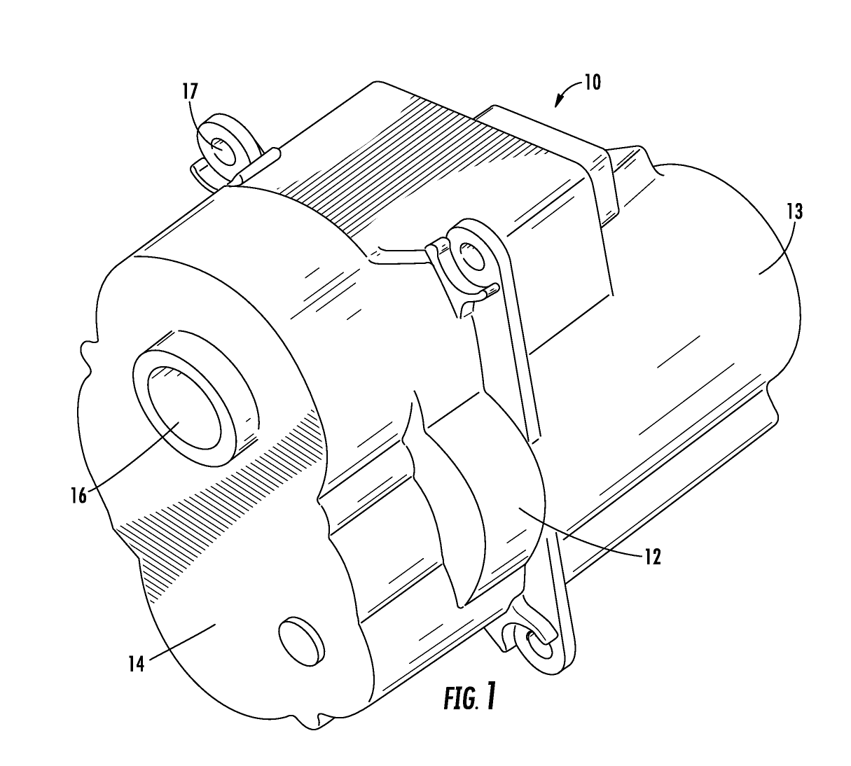

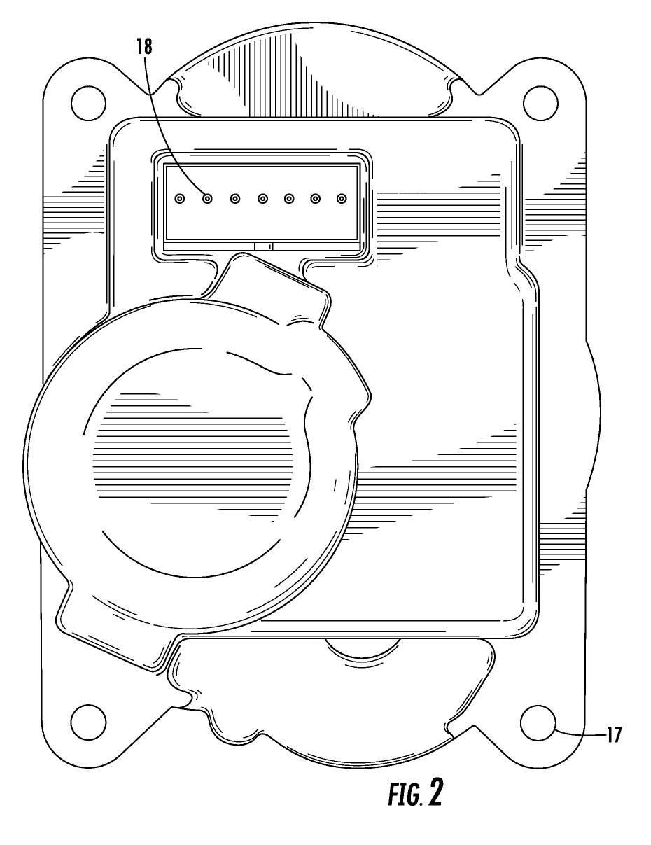

Referring to FIGS. 1-2, there is depicted a gear motor assembly 10 having a gear box 12, lid 13, cover 14, output shaft 16, four (4) mounting holes 17, and an input connector 18. The gear motor assembly 10 is mounted in a conventional manner within a refrigerator/freezer (not shown) or the like wherein the output of the gear motor assembly 10, provided via the output shaft 20, is used in the production and/or delivery of shaved, crushed and cubed ice (not shown).

As will be appreciated by those having ordinary skill in the art, the speed (i.e., rpm) and direction (i.e., clockwise or counterclockwise) of the output shaft 20 to the gear motor assembly 10 is directly correlated to the speed (i.e., rpm) and direction (i.e., clockwise or counterclockwise) of the output shaft 20 to the base motor 22. In an embodiment, a reduction in the output of the base motor 22 is accomplished by a conventional four (4) stage gear train (not shown) contained within the gear box assembly 24. Accordingly, the gear train is operatively connected to the output shaft 20 of the gear box assembly 24 and the input shaft 26 of the base motor 22 contained within the gear box assembly 24. In an embodiment, the gear train can provide a speed reduction that reduces an input speed of 12,000 rpm provided by the base motor 22 to a speed of 130 rpm on the output gear, which corresponds to a gear ratio of about 89.4:1.

In an embodiment, the production and/or delivery of shaved ice desirably occurs with the output shaft 20 of the gear box assembly 24 operating at about 130 rpm in a clockwise direction. In addition, the production and/or delivery of crushed ice is to occur with the output shaft 20 of the gear box assembly 24 operating at about 130 rpm in a counterclockwise direction. Finally, the production and/or delivery of cubed ice is to occur with the output shaft 20 operating at about 32 rpm.

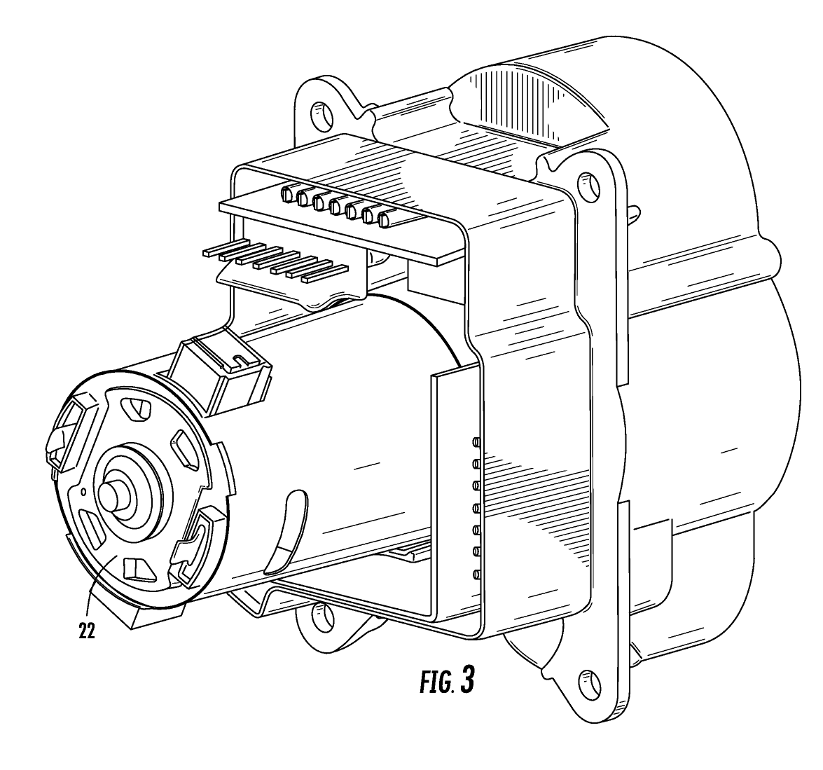

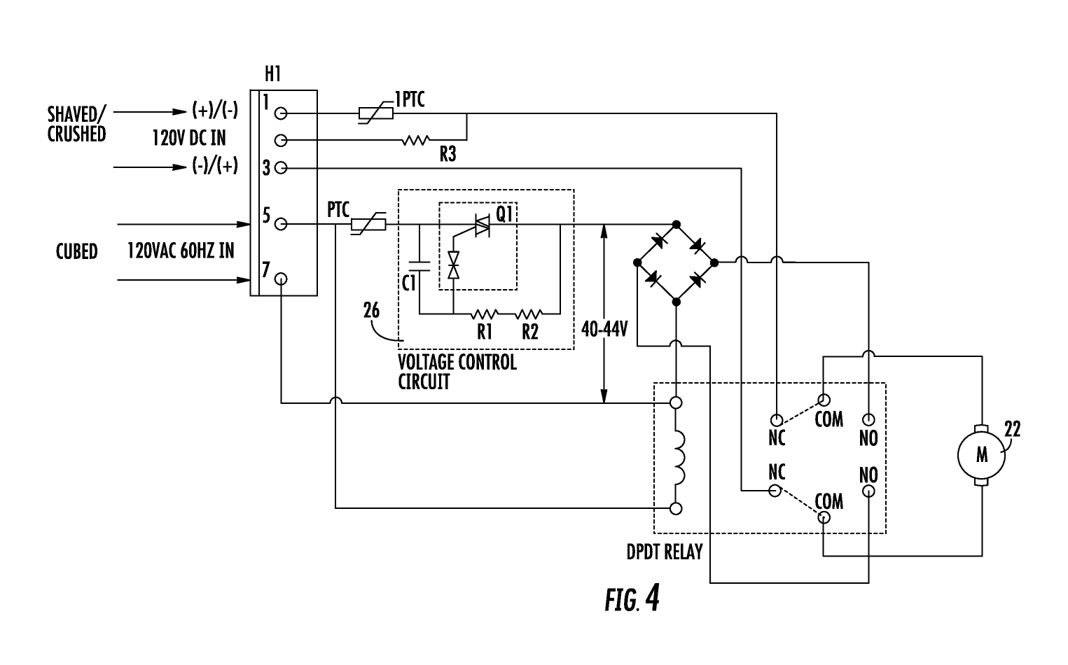

The shaved ice operation mode of the gear motor assembly 10 occurs when a voltage of 120VDC is introduced on pins 1 and 3 of the input connector shown in FIGS. 2, 3 and 4. This voltage can be introduced by, or result at least in part from, a user depressing a switch or the like on the outside of a refrigerator/freezer for selecting the shaved ice mode of operation. As shown in FIG. 4, the 120VDC voltage applied on pins 1 and 3 is received by the base motor 22 via a DPDT relay, which is normally in the closed position (i.e., the state when power is not applied to operate the relay). As a result, the base motor 22 will activate to cause the output shaft 20 of the gear box assembly 24 to rotate at about 130 rpm in a clockwise direction.

The crushed ice operation mode of the gear motor assembly 10 occurs when the polarity of the 120VDC input voltage is reversed on pins 1 and 3 of the input connector shown in FIGS. 2, 3 and 4. Reversing the polarity of the input voltage can be accomplished by, or result at least in part from, a user depressing a switch or the like on the outside of a refrigerator/freezer for selecting the crushed ice mode of operation. Once again, as shown in FIG. 4, the 120VDC voltage applied on pins 1 and 3 is received by the base motor 22 via the DPDT relay, which is in the normally closed position. However, as a result of the polarity of the input voltage being reversed, the base motor 22 will activate to cause the output shaft 20 of the gear box assembly 24 to rotate at about 130 rpm in a counterclockwise direction.

The cubed ice operation mode of the gear motor assembly 10 occurs by applying an input voltage of 120VAC to pins 5 and 7 of the input connector shown in FIGS. 2, 3 and 4. As indicated previously, this voltage can be introduced by, or result at least in part from, a user depressing a switch or the like on the outside of a refrigerator/freezer for selecting the cubed ice mode of operation. As a result of applying the input voltage of 120VAC to pins 5 and 7, the DPDT relay of FIG. 4 will switch to the normally closed position. Moreover, the input voltage received at pins 5 and 7 will be reduced by a voltage control circuit 26 (FIG. 4) to about 40-44 VAC and then pass through a full-wave bridge rectifier. As such, the voltage output of the rectifier is passed through the switched DPDT relay and is received by the base motor 22 to activate the motor and thus cause the output shaft 20 of the gear box assembly 24 to rotate at about 32 rpm in a clockwise direction.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the applicants' contribution.

What is claimed is:

1. A gear motor assembly capable of operation in three modes, the assembly comprising:
a reversible motor having an input shaft;
a gear train assembly coupled to the input shaft;
an output shaft coupled to the gear train assembly;
a power source, electrically coupled to the motor, for producing an operating voltage;
an input signal for directing the operating voltage from the power source through one of either:
a relay for switching the polarity of the operating voltage directed from the power source to the motor, thereby reversing the motor; and
a voltage control circuit for reducing the voltage to the motor;
wherein the input signal causes the motor to operate at any one of:
a first speed in a clockwise direction,
a first speed in a counter-clockwise direction, and
a second speed.

2. The gear motor assembly of claim 1, wherein the first speed is about 130 rpms.

3. The gear motor assembly of claim 1, wherein the second speed is about 32 rpms.

4. The gear motor assembly of claim 1, further comprising a DPDT relay switch.

5. The gear motor assembly of claim 1, wherein the motor operates to produce and dispense one of either cubed, crushed or shaved ice.

6. The gear motor assembly of claim 5, wherein the gear motor assembly is mounted in an ice making machine.

7. A method for operating a gear motor assembly having a reversible motor with an input shaft, a gear train assembly coupled to the input shaft, an output shaft coupled to the gear train assembly and a power source, electrically coupled to the motor, for producing an operating voltage, the method comprising the steps of:
applying a first operating voltage to the motor to turn the output shaft in a first direction at a first speed;
changing the polarity of the first operating voltage to turn the output shaft in a second direction at the first speed; and
reducing the first operating voltage in a voltage control circuit to turn the output shaft at a second speed slower than the first speed.

8. The method of claim 7, wherein the first operating voltage is 120VAC.

9. The method of claim 7, wherein the first speed is about 130 rpms.

10. The method of claim 7, wherein the second speed is about 32 rpms.

11. The method of claim 10, wherein the first voltage is reduced in the control circuit to a voltage in the range of from about 40 to about 44 VAC.
